(19) United States
(12) Patent Application Publication
(10) Pub. No.: US 2025/0262579 A1
(43) Pub. Date: Aug. 21, 2025

(54) FILTER ELEMENT ASSEMBLY

(71) Applicant: NANJING BEIST ENVIRONMENTAL PROTECTION TECHNOLOGY CO., LTD., Jiangsu (CN)

(72) Inventor: Peng CHEN, Jiangsu (CN)

(73) Assignee: NANJING BEIST ENVIRONMENTAL PROTECTION TECHNOLOGY CO., LTD., Jiangsu (CN)

(21) Appl. No.: 19/200,650

(22) Filed: May 6, 2025

Related U.S. Application Data
(63) Continuation-in-part of application No. PCT/CN2023/130062, filed on Nov. 7, 2023.

(30) Foreign Application Priority Data
Nov. 7, 2022 (CN) 202211383023.6
Nov. 7, 2022 (CN) 202211383112.0

(51) Int. Cl. B01D 35/30; B01D 29/56

(52) U.S. Cl. CPC B01D 35/306; B01D 29/56

(57) ABSTRACT

The present disclosure discloses a filter element assembly. The filter element assembly includes a joint, a filter element, and a locking apparatus for detachably connecting the filter element to the joint. The locking apparatus includes a sliding plate fixing cover provided with a central through hole and mounted at a bottom end of the joint, and a button sliding block provided with a central through hole and arranged between the joint and the sliding plate fixing cover in a slidable manner. The button sliding block includes arc-shaped button sliding plates arranged in a left-right symmetrical manner in a circumferential direction of the joint. One end of the arc-shaped button sliding plate is connected to an elastic element, and the other end thereof is connected to a connecting module; the arc-shaped button sliding plates swing left and right through the connecting module.

### CROSS-REFERENCE TO RELATED APPLICATION

This application is a continuation-in-part of international PCT application serial no. PCT/CN2023/130062, filed on Nov. 7, 2023, which claims the priority benefit of China applications no. 202211383112.0 and 202211383023.6, filed on Nov. 7, 2022. The entirety of each of the above-mentioned patent applications is hereby incorporated by reference herein and made a part of this specification.

### TECHNICAL FIELD

The present disclosure relates to the field of filter element assemblies.

### RELATED ART

Currently, filtering apparatuses are widely used, particularly in the vast market of water purification and drinking water devices. With the development of science and technology, more and more filtering apparatuses and other products have entered the market. The filter element is the core of the filtering apparatus, and the filter element needs to be replaced, maintained, or cleaned after a period of use, which needs to remove the filter element from the filtering apparatus. At present, since the filter element is mainly fixed through connectors by means of rotating buckle connection and threaded connection, the mounting is inconvenient because tools are needed, the mounting torque is high, the water supply or discharge passage cannot be automatically disconnected, the water supply locking apparatus needs to be manually switched for each replacement, and water seeps when the filter element is inverted or positioned horizontally. These problems lead to low work efficiency in filter element detachment and consume considerable time and effort; moreover, the connectors are easy to lose and non-professionals are difficult to operate.

Moreover, existing water purifiers are customized with corresponding housings based on the filtration level requirements of the water purifier. Different outer housing molds are customized for different levels according to different use requirements, and then the filter elements are mounted for use. That is, according to different filtration level requirements, a plurality of joints need to be arranged simultaneously on the entire housing to correspond to each filter element. This not only increases the difficulty in the mold manufacturing process of the entire housing, but also raises production costs and consumes considerable time and effort.

Based on the above problems, the affiliated enterprise, Nanjing Black Orange Environmental Protection Technology Co., Ltd. (the legal person is the same as the inventor of the present disclosure), of the applicant of the present disclosure develops a filtering apparatus with an easily replaceable use joint, with Application No. 201621378691.X, and the filtering apparatus achieves the convenient replacement of the filter element by adopting a linear movement mode of a button sliding block. Based on the research and development technology, the applicant continuously researches and develops a new filter element assembly that is convenient for replacing the filter element and a modular water purifier based on the filter element assembly.

### SUMMARY OF INVENTION

### Objective

The present disclosure aims to provide a filter element assembly that is convenient for quickly replacing a filter element.

### Technical Solutions

The filter element assembly of the present disclosure includes a joint, a filter element, and a locking apparatus for detachably connecting the filter element to the joint. The locking apparatus includes a sliding plate fixing cover provided with a central through hole and mounted at a bottom end of the joint, and a button sliding block provided with a central through hole and arranged between the joint and the sliding plate fixing cover in a slidable manner. The button sliding block includes arc-shaped button sliding plates arranged in a left-right symmetrical manner in a circumferential direction of the joint. One end of the arc-shaped button sliding plate is connected to an elastic element, and the other end thereof is connected to a connecting module; the arc-shaped button sliding plates swing left and right through movement of the connecting module.

Further, according to the filter element assembly, the connecting module includes connecting rods connected to the arc-shaped button sliding plates, the other ends of the connecting rods are arranged on a connecting block in a vertically rotating and staggered manner, the connecting block is fixedly arranged on a connecting link, and the arc-shaped button sliding plates swing left and right based on a thrust of the connecting rods and the elastic elements.

Further, according to the filter element assembly, the connecting module includes a sliding block with two inclined edges, the two inclined edges of the sliding block abut against the arc-shaped button sliding plates, respectively, the other end of the sliding block is provided with a connecting link in a connecting manner, and the arc-shaped button sliding plates swing left and right based on a thrust of the sliding block and the elastic elements.

Further, according to the filter element assembly, several grooves are formed in a side surface of the arc-shaped button sliding plate, protrusions corresponding to the grooves are arranged at an upper end of the filter element, and surfaces of the groove and the protrusion that are in contact are inclined surfaces.

Further, according to the filter element assembly, the sliding plate fixing cover is provided with notches corresponding to the grooves of the arc-shaped button sliding plates.

Further, according to the filter element assembly, the joint is provided with passages for water to flow, and the filter element is used to accommodate a filtering material, an upper end of the filter element being provided with filtering passages corresponding to the passages.

Further, according to the filter element assembly, the sliding plate fixing cover is connected to the joint through bolts, and the arc-shaped button sliding plate is provided with grooves for the arc-shaped button sliding plate at positions to which the bolts are connected.

Further, according to the filter element assembly, a supporting plate for placing the connecting module is arranged on the joint in an outward extending manner, and the connecting link penetrates through the supporting plate.

Further, according to the filter element assembly, the joint is provided with a baffle at a position where the elastic elements are connected.

The modular water purifier based on the filter element assembly includes a water path board assembly composed of a water path board and several joints and locking apparatuses arranged on the water path board, filter elements cooperating with the joints on the water path board assembly, and push rods cooperating with the locking apparatuses on the water path board assembly, where one end of the push rod is in contact with the connecting link, and the connecting link drives the arc-shaped button sliding plates to swing left and right, thereby achieving mounting and detachment of the filter element.

Beneficial effects: Compared with the prior art, the remarkable advantages of the present disclosure are as follows: based on the linear movement mode of the existing button sliding block, the filter element assembly achieves quick replacement of the filter element and the joint by using a locking apparatus consisting of arc-shaped button sliding plates and a connecting module of different structures and adopting a novel movement mode of arc-shaped left and right swinging.

In the modular water purifier based on the filter element assembly, the joint, the locking apparatus, and the push rod form a modular filter element assembly, and the joint and the locking apparatus are directly arranged on the water path board, such that water purification requirements for different levels can be met by designing only the water path board, which effectively avoids the need to replace the entire housing and filter element as in existing water purifiers, achieves a modular design, and reduces the manufacturing cost of the housing mold, thereby improving the economic benefits of the enterprise. Moreover, when a certain filter element assembly in the water purifier is damaged, only the corresponding filter element assembly needs to be replaced rather than the entire water purifier, thereby reducing the use cost.

### BRIEF DESCRIPTION OF DRAWINGS

FIG. 1 is a first schematic structural diagram of a joint and a locking apparatus of a filter element assembly according to the present disclosure.

FIG. 2 is a second schematic structural diagram of a joint and a locking apparatus of a filter element assembly according to the present disclosure.

FIG. 3 is a third schematic structural diagram of a joint and a locking apparatus of a filter element assembly according to the present disclosure.

FIG. 4 is a schematic structural diagram of a filter element according to the present disclosure.

FIG. 5 is a schematic structural diagram of a water path board assembly according to the present disclosure.

FIG. 6 is a schematic structural diagram of a modular water purifier (without a housing) according to the present disclosure.

FIG. 7 is a schematic structural diagram of a modular water purifier (with a housing) according to the present disclosure.

FIG. 8 is a partial cross-sectional diagram of a modular water purifier (without a housing) according to the present disclosure.

### DESCRIPTION OF EMBODIMENTS

The technical solutions of the present disclosure are further described in detail below with reference to the drawings.

The filter element assembly of the present disclosure includes a joint 1, with passages for water to flow formed therein; a filter element 2 for accommodating a filtering material, where the upper end of the filter element is provided with filtering passages corresponding to the passages; and a locking apparatus 3 for detachably connecting the filter element 2 to the joint 1.

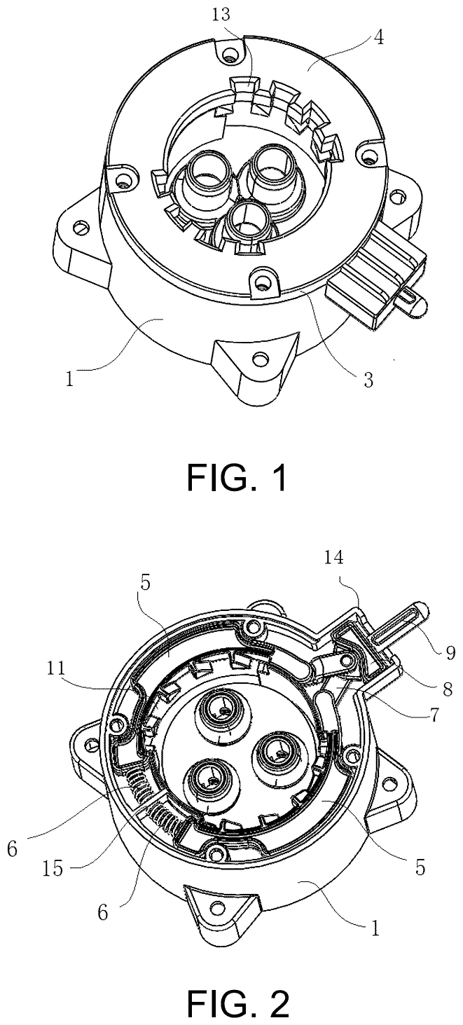

As shown in FIG. 1, the locking apparatus 3 includes a sliding plate fixing cover 4 provided with a central through hole, where the sliding plate fixing cover 4 is arranged at the lower end of the joint 1; and a button sliding block provided with a central through hole and arranged between the joint 1 and the sliding plate fixing cover 4 in a slidable manner.

### Embodiment 1

As shown in FIG. 2, the button sliding block of the filter element assembly includes two arc-shaped button sliding plates 5 arranged in the circumferential direction of the joint 1, and the two arc-shaped button sliding plates 5 are arranged in a left-right symmetrical manner. One end of the two arc-shaped button sliding plates 5 is directly connected to an elastic element 6 (preferably a spring), and correspondingly, a baffle 15 may be arranged in the joint 1 at a position where the elastic elements 6 are connected, such that the spring abuts against the joint 1. The other end of the two arc-shaped button sliding plates 5 is connected to a connecting module, and the arc-shaped button sliding plates 5 swing left and right through the movement of the connecting module, thereby achieving the convenient detachment and mounting of the filter element 2. The connecting module includes connecting rods 7, a connecting block 8, and a connecting link 9, the connecting rods 7 are connected to the connecting block 8, and the connecting rods 7 are respectively located on the upper and lower sides of the connecting block 8 and are movably connected. The other end of the connecting block 8 is fixedly arranged on the connecting link 9. The other end of the two arc-shaped button sliding plates 5 is connected to the connecting rod 7, and the two may be movably connected by using a known connecting block and connecting groove or may be integrally formed.

Several grooves 11 are formed in the side surface of the arc-shaped button sliding plate 5 of the button sliding block facing the through hole, and correspondingly, the filter element 2 is provided with several protrusions 12 matching the grooves 11, and the surfaces of the groove 11 and the protrusion 12 that are in contact are both inclined surfaces, as shown in FIGS. 2 and 4. Based on this, the locking and detachment between the filter element 2 and the joint 1 are achieved. The sliding plate fixing cover 4 is provided with notches 13 corresponding to the grooves 11 of the arc-shaped button sliding plates 5, as shown in FIG. 1.

The sliding plate fixing cover 4 and the joint 1 of the filter element assembly of the embodiment may be further connected through bolts, and correspondingly, grooves for the arc-shaped button sliding plate are formed in the two arc-shaped button sliding plates 5 at positions to which the bolts are connected, thereby preventing the arc-shaped button sliding plates 5 from being limited in movement. A supporting plate 14 for placing the connecting module is arranged on the joint 1 in an outward extending manner, and the connecting link 9 of the connecting module penetrates through the supporting plate 14 to facilitate the subsequent achievement of a modular filter element assembly.

### Embodiment 2

Embodiment 2 and Embodiment 1 achieve the left and right swinging of the arc-shaped button sliding plate by using connecting modules with two different structural forms. Specifically:

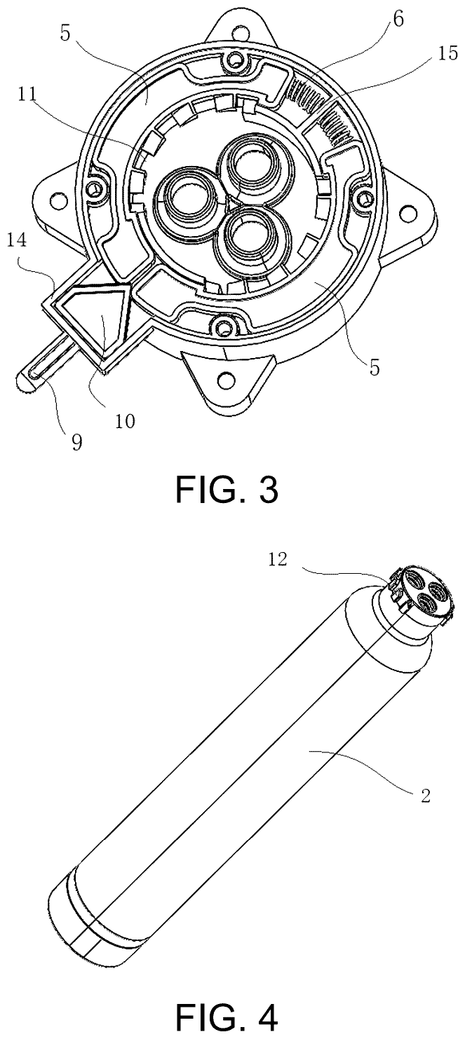

As shown in FIG. 3, the button sliding block of the filter element assembly includes two arc-shaped button sliding plates 5 arranged in the circumferential direction of the joint 1, and the two arc-shaped button sliding plates 5 are arranged in a left-right symmetrical manner. One end of the two arc-shaped button sliding plates 5 is connected to an elastic element 6 (preferably a spring) to abut against the joint 1, and correspondingly, a baffle 15 may be arranged in the joint 1 at a position where the elastic elements 6 are connected, such that the spring abuts against the joint. The other end of the two arc-shaped button sliding plates 5 is in contact with a wedge-shaped sliding block 10 (i.e., a sliding block 10 provided with two inclined surfaces), and the arc-shaped button sliding plates 5 swing left and right through the movement of the sliding block 10, thereby achieving the convenient detachment and mounting of the filter element 2. That is, the two inclined surfaces of the sliding block 10 are in contact with the arc-shaped button sliding plates 5, respectively, and then the arc-shaped button sliding plates 5 swing left and right through the thrust of the sliding block. The other end of the sliding block 10 is connected to a connecting link 9.

Several grooves 11 are formed in the side surface of the arc-shaped button sliding plate 5 of the button sliding block facing the through hole, and correspondingly, the filter element 2 is provided with several protrusions 12 matching the grooves 11, and the surfaces of the groove 11 and the protrusion 12 that are in contact are both inclined surfaces, as shown in FIGS. 3 and 4. Based on this, the locking and detachment between the filter element 2 and the joint 1 are achieved. The sliding plate fixing cover 4 is provided with notches 13 corresponding to the grooves 11 of the arc-shaped button sliding plates 5, as shown in FIG. 1.

The sliding plate fixing cover 4 and the joint 1 of the filter element assembly of the embodiment may be further connected through bolts, and correspondingly, grooves for the arc-shaped button sliding plate are formed in the two arc-shaped button sliding plates 5 at positions to which the bolts are connected, thereby preventing the arc-shaped button sliding plates 5 from being limited in movement. A supporting plate 14 for placing the sliding block 10 is arranged on the joint 1 in an outward extending manner, and the connecting link 9 of the connecting module penetrates through the supporting plate 14 to facilitate the subsequent achievement of a modular filter element assembly.

In addition, the arrangement of the internal water path structure of the filter element according to the present disclosure is the same as the technical solutions disclosed in Application No. 201621378691.X, entitled “FILTERING APPARATUS WITH EASILY REPLACEABLE USE JOINT”, which is not reiterated in the present disclosure. The filter element of the present disclosure is also provided with a guide groove convenient for mounting, such that the filter element 2 and the joint 1 are accurately aligned.

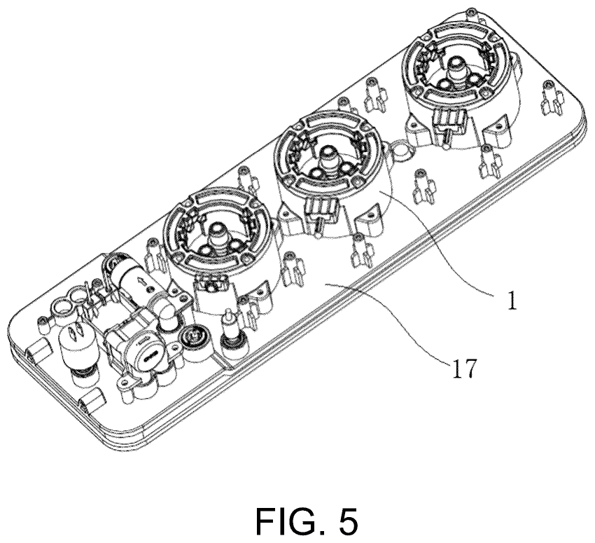

As shown in FIG. 5, a water path board assembly of the present disclosure includes a water path board 17 and several joints 1 arranged on the water path board 17, and the specific water path arrangement on the water path board 17 is flexibly set according to the number of joints provided, which is not further limited in the present disclosure. Similarly, the water path board may further include necessary components such as a water pump 18 for extracting water from the source, which are well known in the art and are not further limited in the present disclosure.

As shown in FIG. 5, the water path board assembly further includes locking apparatuses 3 arranged on the joints 1, and the joint 1, the locking apparatus 3, and a filter element 2 are combined to form a filter element assembly.

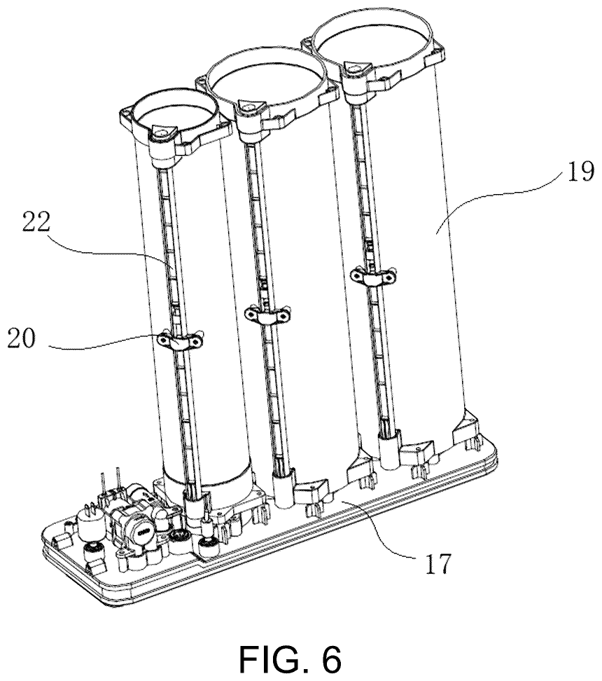

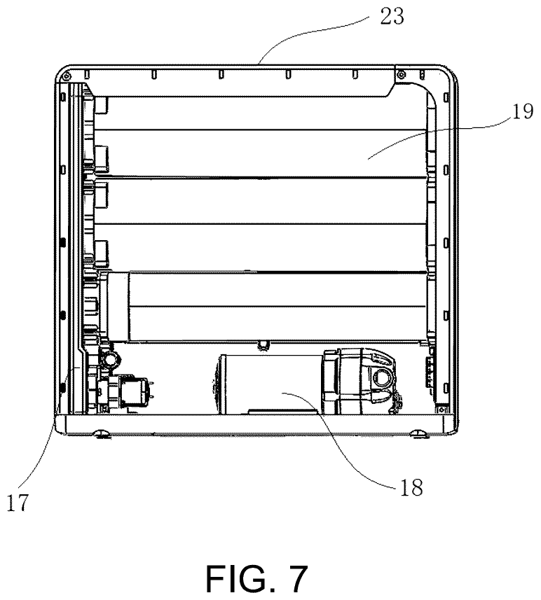

In the present disclosure, the above water path board assembly is used to prepare a modular water purifier. As shown in FIG. 6, the modular water purifier includes the water path board assembly and housings 19 arranged on the water path board assembly and connected to the joints 1. The housing 19 is provided with the filter element 2 cooperating with the joint 1, a circular protruding part is arranged at the tail end part of the filter element 2, and a guide plate for facilitating mounting of the filter element is arranged on the protruding part. The housing is provided with a push rod 22 cooperating with the connecting link 21 of the connecting module on the water path board assembly through a push rod supporting frame 20 in a connecting manner, one end of the push rod 22 is in contact with the connecting link 21, and then the connecting link 21 drives the arc-shaped button sliding plates 5 to swing left and right, thereby achieving the mounting and detachment of the filter element 2. In addition, the water purifier may further include a shell 23, as shown in FIG. 7.

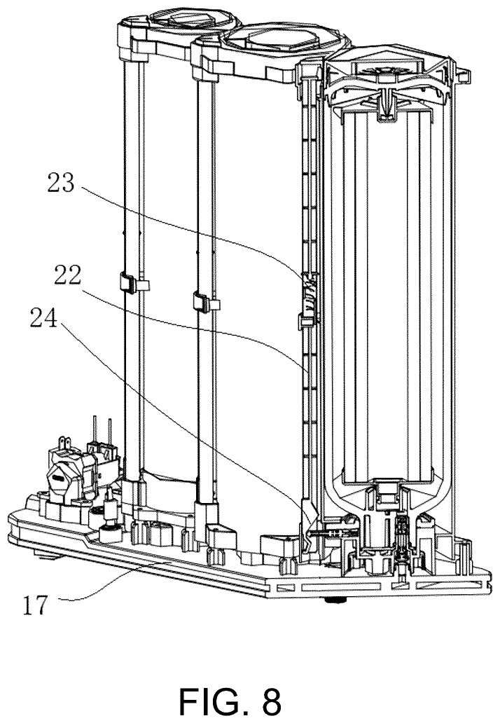

Correspondingly, to achieve the effective movement of the above moving mechanism, as shown in FIG. 8, several push rod springs 23 are arranged on the push rod 22 in the axial direction thereof. The end of the push rod 22 that is in contact with the connecting link 21 is provided with a concave slope 24, and locking and unlocking are achieved by the contact of the slope 24 with the connecting link 21. The other end of the push rod 22, that is, the position corresponding to the circular protruding part of the filter element 2, is provided with a button module, and by pressing the button module, the push rod 22 is driven to reciprocate, thereby driving the arc-shaped button sliding plates 5 to swing left and right.

In addition, the arrangement of the internal water path structure of the filter element according to the present disclosure is the same as the technical solutions disclosed in Application No. 201621378691.X, entitled “FILTERING APPARATUS WITH EASILY REPLACEABLE USE JOINT”, which is not reiterated in the present disclosure.

The working principle is as follows: the push button module is pressed, such that the push rod moves backward; due to the arrangement of the concave slope at the other end of the push rod, the push rod drives the button sliding block to move in a direction perpendicular to the axial direction of the filter element during movement; in this case, the grooves in the arc-shaped button sliding plates and the grooves in the sliding plate fixing cover are in communication to form passages; the filter element is ejected out under the action of the filter element check valve and the valve core spring, and the filter element is replaced by grasping the circular protruding part of the filter element. When a new filter element is mounted after replacement, due to the cooperation of the inclined surfaces of the groove and the protrusion that are in contact, the new filter element is directly inserted after replacement.

What is claimed is:

1. A filter element assembly, wherein the filter element assembly comprises a joint, a filter element, and a locking apparatus detachably connecting the filter element to the joint, wherein the locking apparatus comprises a sliding plate fixing cover provided with a central through hole and mounted at a bottom end of the joint, and a button sliding block provided with a central through hole and arranged between the joint and the sliding plate fixing cover in a slidable manner, wherein the button sliding block comprises arc-shaped button sliding plates arranged in a left-right symmetrical manner in a circumferential direction of the joint, one end of the arc-shaped button sliding plate is connected to an elastic element, the other end thereof is connected to a connecting module, and the arc-shaped button sliding plates swing left and right through movement of the connecting module.

2. The filter element assembly according to claim 1, wherein the connecting module comprises connecting rods connected to the arc-shaped button sliding plates, the other ends of the connecting rods are arranged on a connecting block in a vertically rotating and staggered manner, the connecting block is fixedly arranged on a connecting link, and the arc-shaped button sliding plates swing left and right based on a thrust of the connecting rods and the elastic elements.

3. The filter element assembly according to claim 1, wherein the connecting module comprises a sliding block with two inclined edges, the two inclined edges of the sliding block abut against the arc-shaped button sliding plates, respectively, the other end of the sliding block is provided with a connecting link in a connecting manner, and the arc-shaped button sliding plates swing left and right based on a thrust of the sliding block and the elastic elements.

4. The filter element assembly according to claim 2, wherein several grooves are formed in a side surface of the arc-shaped button sliding plate, protrusions corresponding to the grooves are arranged at an upper end of the filter element, and surfaces of the groove and the protrusion that are in contact are inclined surfaces.

5. The filter element assembly according to claim 2, wherein the sliding plate fixing cover is provided with notches corresponding to the grooves of the arc-shaped button sliding plates.

6. The filter element assembly according to claim 2, wherein the joint is provided with passages for water to flow, and the filter element is used to accommodate a filtering material, an upper end of the filter element being provided with filtering passages corresponding to the passages.

7. The filter element assembly according to claim 2, wherein the sliding plate fixing cover is connected to the joint through bolts, and the arc-shaped button sliding plate is provided with grooves for the arc-shaped button sliding plate at positions to which the bolts are connected.

8. The filter element assembly according to claim 2, wherein a supporting plate for placing the connecting module is arranged on the joint in an outward extending manner, and the connecting link penetrates through the supporting plate.

9. The filter element assembly according to claim 2, wherein the joint is provided with a baffle at a position where the elastic elements are connected.

10. The filter element assembly according to claim 3, wherein several grooves are formed in a side surface of the arc-shaped button sliding plate, protrusions corresponding to the grooves are arranged at an upper end of the filter element, and surfaces of the groove and the protrusion that are in contact are inclined surfaces.

11. The filter element assembly according to claim 3, wherein the sliding plate fixing cover is provided with notches corresponding to the grooves of the arc-shaped button sliding plates.

12. The filter element assembly according to claim 3, wherein the joint is provided with passages for water to flow, and the filter element is used to accommodate a filtering material, an upper end of the filter element being provided with filtering passages corresponding to the passages.

13. The filter element assembly according to claim 3, wherein the sliding plate fixing cover is connected to the joint through bolts, and the arc-shaped button sliding plate is provided with grooves for the arc-shaped button sliding plate at positions to which the bolts are connected.

14. The filter element assembly according to claim 3, wherein a supporting plate for placing the connecting module is arranged on the joint in an outward extending manner, and the connecting link penetrates through the supporting plate.

15. The filter element assembly according to claim 3, wherein the joint is provided with a baffle at a position where the elastic elements are connected.
